(19) United States
(12) Patent Application Publication
(10) Pub. No.: US 2013/0275859 A1
(43) Pub. Date: Oct. 17, 2013

(54) Creating Applications for Popular Web Page Content

(71) Applicants: Eamonn O'Brien-Strain, San Francisco, CA (US); Suk Hwan Lim, Mountain View, CA (US)

(72) Inventors: Eamonn O'Brien-Strain, San Francisco, CA (US); Suk Hwan Lim, Mountain View, CA (US)

(21) Appl. No.: 13/817,731

(22) PCT Filed: Dec. 14, 2010
(86) PCT No.: PCT/US10/60304

§ 371 Date: Feb. 19, 2013

(51) Int. Cl. G06F 17/22

(52) U.S. Cl. CPC G06F 17/2247
USPC 715/234

(57) ABSTRACT

A method of creating an application for the popular selection of content on a web page (FIG. 4, 400) may comprise collecting web page data associated with a web page (FIG. 4, 400), the web page data comprising a selection of content on the web page (FIG. 4, 400) (Block 505), with a processor, determining among the selection of content of the web page, which content is popular (Block 510), and creating an application based on the popular selection of content of the web page (Block 515).

### BACKGROUND

Web pages provide an inexpensive and convenient way to make information available to other individuals including, for example, consumers of products, students, and media enthusiasts. However, as the inclusion of multimedia content, embedded advertising, and online services becomes increasingly more prevalent in modern web pages, the web pages themselves have become substantially more complex. For example, in addition to their main content, many web pages display auxiliary content such as background imagery, advertisements, navigation menus, and links to additional content, among others,

It is often the case that web page owners, web page developers, or individuals that visit web pages wish to utilize only a portion of the information presented in a web page. Automatic selection of desired content in web pages can eliminate extraneous or undesired content and significantly streamline a number of workflows. For instance, a user may desire to print, a physical copy of an article located at an online news website without reproducing any of the other content on the web page containing the article, such as advertising, links, to other content, etc. Similarly, an owner of a web page may wish to adapt a web page into another document, such as a marketing brochure, without including content in the web page that is superfluous to the new document. Additionally, a user may wish to display only the most relevant web content on a computing device that has a limited screen size such as a mobile smart phone. Other applications that may benefit from automatic selection of desired content in web pages include, for example, search, information retrieval, information management, archiving, and other applications.

### BRIEF DESCRIPTION OF THE DRAWINGS

The accompanying drawings illustrate various embodiments of the principles described herein and are a part of the specification. The illustrated embodiments are merely examples and do not limit the scope of the claims,

FIG. 1 is a diagram of an illustrative system for creating an application for the popular selection of the content on a web page, and present the popular selection of content of the web page to a user for printing, viewing, archiving, or any other useful purpose via the application, according to one example of principles described herein,

FIG. 2 is a simplified partial representation of a Document Object Model (DOM) tree for an illustrative web page, according to one example of principles described herein.

FIG. 3 is a layout of an illustrative web page that corresponds to the Document Object Model (DOM) tree of FIG. 2, according to one example of principles described herein.

FIG. 4 is an illustrative diagram of a web page showing the content of the web page corresponding to the Document Object Model (DOM) tree of FIG. 2 and the layout of the web page of FIG. 3, according to one example of principles described herein.

FIG. 5 is a flowchart depicting an illustrative method for creating an application for the popular selection of the content on a web page, and presenting the popular selection of content of the web page to a user for printing, viewing, archiving, or any other useful purpose via the application according to one example of the principles described herein.

FIG. 6 is a flowchart depicting an illustrative method for creating an application for the popular selection of the content on web pages, and presenting the popular selection of content of the web pages to a user for printing, viewing, archiving, or any other useful purpose via the application, according to another example of the principles described herein.

FIG. 7 is a flowchart depicting an illustrative method for creating an application for the popular selection of the content on web pages using a popular selection of users with similar characteristics or demographics, according to yet another example of the principles described herein.

Throughout the drawings, identical reference numbers designate similar, but not necessarily identical, elements,

### DETAILED DESCRIPTION

The present specification discloses systems and methods of creating applications for popular web page content. As discussed above, there are many applications where automatically selecting one or more portions of a web page can be advantageous. For purposes of explanation, the specification uses the illustrative example of selecting popular portions of a web page to create applications for popular web page content. Currently, when a web page is printed or displayed, it includes a variety of contents. For example, in addition to the main content, many web pages display content such as background imagery, advertisements, navigation menus, headers/footers, and links to additional content, among others. Some of the content of a web page may be print worthy, but the user may not want to print some or all of the auxiliary content. Ideally, the present system and method may access web page data associated with a web page, the web page data comprising a popular selection of content on the web page, create an application for the popular selection of the content on the web page, and present the popular selection of content of the web page to a user for printing, viewing, archiving, or any other useful purpose via the application.

As used in the present specification and in the appended claims, the term “web page” is meant to be understood broadly as any document that can be retrieved from a server over a network connection and viewed in a web browser application. For example, a web page may be a document accessed by a Uniform Resource Locator (URL) on the World Wide Web over a network such as the Internet. Further, as used in the present specification and in the appended claims, the term “web page data” is meant to be understood broadly as any data relating to a web page, For example, web page data may include the web page's Uniform Resource Locator (URL): the web page's Document Object Model (DOM); information relating to the structure and layout of a Document Object Model (DOM) tree of the web page; the layout and structure of any nodes within the Document Object Model (DOM) tree: content of a web page or nodes previously or currently selected by a viewer within a Document Object Model (DOM) tree; content of a web page or nodes not previously or currently selected by a viewer within a Document Object Model (DOM) tree; any data relating to the amount or characteristics of any type of content of the web page selected or not selected by an individual, entity; or combinations of these. Web page data may additionally include any metadata associated with or describing any of the above mentioned types of data. Still further, web page data may also include any data or metadata relating not only to the content of a web page an individual has selected from any one web page in the past, but may also include information relating to when and how often the viewer had previously viewed, utilized, or adapted a web page or content on a web page.

Still further, as used in the present specification and in the appended claims, the term “similar web page” or similar language is meant to be understood broadly as any web page having similar characteristics as compared to another web page. For example, a similar web page may be similar in the type of template used to arrange the text, images or other content displayed on the web page. A similar web page may also be similar because, although the web page address or Uniform Resource Locator (URL) is of entirely identical, the domain name within the Uniform Resource Locator (URL) is the same. Additionally, a similar web page may be similar in the content displayed on the web page.

Additionally, as used in the present specification and in the appended claims, the term “user” is meant to be understood broadly as any person viewing or otherwise utilizing a web page. Therefore, an owner or administrator of a web page, a user of a computing system having accessed a web page, or any other person may be a viewer or user. Still further, as used in the present specification and in the appended claims, the term “user desirable content” is meant to be understood broadly as that content on a web page that a user or viewer wishes to view, utilize or adapt for any purpose. Indeed, the present specification may refer to “desirable” content within a web page that is meant to be understood as those sections of text, images, or any other content on a web page that the user may generally wish to view, utilize or adapt,

Still further, as used in the present specification and in the appended claims, the term “other users” or “crowd” is meant to be understood broadly as any number of people, including one person, other than the user as described above. Further, as used in the present specification and in the appended claims, the terms “crowd consensus” or “popular selection” are meant to be understood broadly as any method and associated algorithms that aggregate the statistical distribution of what parts of a web page have been selected previously, and determines what portions of the web page are considered to be most popular or are part of a consensus of one or more people. For example, the crowd consensus or popular selection may be determined by a frequency count, a voting scheme, a weighted counting scheme, a ranking of a type of selection, or combinations thereof, among others. In one example, a crowd consensus or popular selection may be made by any number of persons including, for example, a user, other users, or combinations of these. Also, a crowd consensus or popular selection may be based on, for example, how often a portion of a web page was selected, what portion or portions of a web page were selected, how consistently a particular portion of a web page was selected, various types of satistical correlations between how related portions of a web page were selected, the weight of the portions of the web pages that were selected, a rank of a type of selection made within the web page, or combinations thereof, among others.

Still further, as used in the present specification and in the appended claims, the term “similar web page” or similar language is meant to be understood broadly as any web page having similar characteristics as compared to another web page. For example, a similar web page may be similar in the type of template used to arrange the text, images or other intent displayed on the web page. A similar web page may also be similar because, although the web page address or Uniform Resource Locator (URL) is not entirely identical, the domain name within the Uniform Resource Locator (URL) is the same. Additionally, a similar web page may be similar in the content displayed on the web page.

Further, as used in the present specification and in the appended claims, the term “app” or “application” is meant to be understood broadly as any computer program or programs, or any machine readable instructions (including software) component or components that, when executed by a processor, provide functionality in direct support of a specific process or processes. In one example, an app or application may be a lightweight application, a smaller application comprising fewer machine readable instructions (such as software) software components or using less memory for storage in a data storage device.

Additionally, as used in the present specification and in the appended claims, the term “user” is meant to be understood broadly as any person viewing or otherwise utilizing a web page. Therefore, an owner or administrator of a web page, a user of a computing system having accessed a web page, or any other person may be a user. Still further, as used in the present specification and in the appended claims, the term “user desirable content” is meant to be understood broadly as that content on a web page that a user or viewer wishes to view, utilize or adapt for any purpose. Indeed, the present specification may refer to “desirable” content within a web page that is meant to be understood as those sections of text, images, any other content on a web page that the user may generally wish to view, utilize, or adapt. Still further, as used in the present specification and in the appended claims, the term “other users” or “crowd” is meant to be understood broadly as any number of people, including one person, other than the user as described above.

Even still further, as used in the present specification and in the appended claims, the term “sub-node” is meant to be understood broadly as any node within a Document Object Model (DOM) tree that has at least one node located on a higher level in the hierarchal order of the Document Object Model (DOM) tree. Therefore, a sub-node may be a sub-node of a node that is itself a sub-node. Additionally, a sub-node may also comprise a number of sub-nodes itself.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

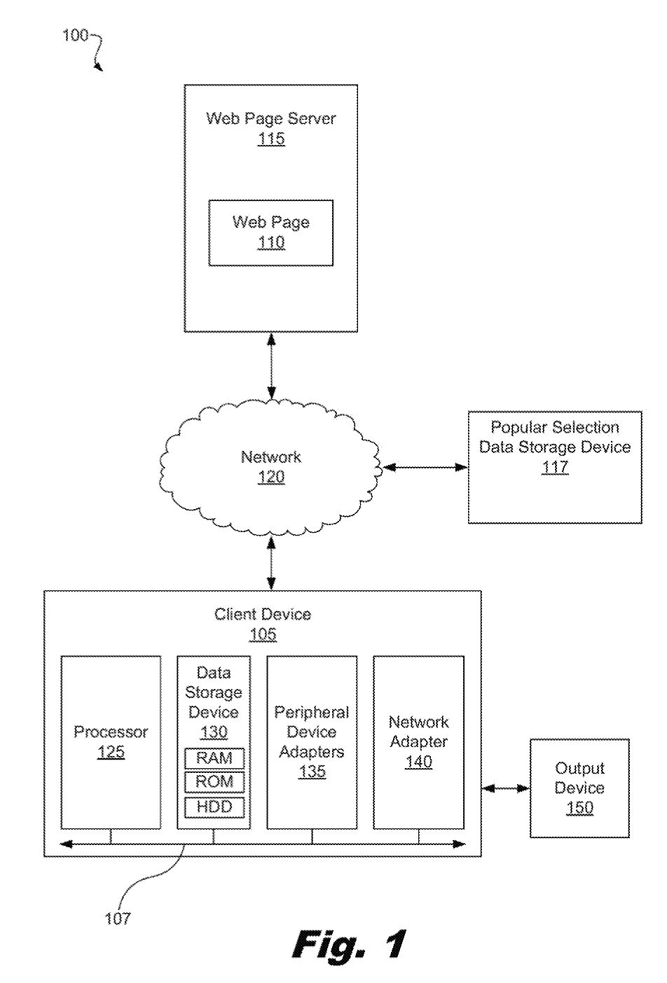

Referring now to FIG. 1, an illustrative system (100) for creating an application for the popular selection of the content on a web page (110), and sent the popular selection of content of the web page to a user for printing, viewing, archiving, or any other useful purpose via the application is depicted. The system (100) may include a client device (105) that has access to a web page (110) stored by a web page server (115). In the present example, for the purposes of simplicity in illustration, the client device (105) and the web page server (115) are separate computing devices communicatively coupled to each other through a mutual connection to a network (120). However, the principles set forth in the present specification extend equally to any alternative configuration in which a client device (105) has complete access to a web page (110). As such, alternative examples within the scope of the principles of the present specification include, but are not limited to, examples in which the client device (105) and the web page server (115) are implemented by the same computing device, examples in which the functionality of the client device (105) is implemented by multiple interconnected computers, for example, a server in a data center and a user's client machine, examples in which the client device (105) and the web page server (115) communicate directly through a bus without intermediary network devices, and examples in which the client device (105) has a stored local copy of the web page (110) that is to be analyzed to select the desirable content from the web page (110).

The client device (105) of the present example is a computing device that retrieves web page data associated with the web page (110) hosted by the web page server (115). The client device further creates an application for the popular selection of the content on the web page, and presents the popular selection of content of the web page to a user for printing, viewing, archiving, or any other useful purpose via the application. In one example, the client device (105) is a printer with the capability of creating such an application, and printing a physical copy of the popular selection of content of the web page. In still another example, the client device (105) may be a desktop computer with the capability of creating such an application, and displaying the popular selection of content of the web page on an output device of the desktop computer.

In another example, the client device (105) is a mobile computing device such as a mobile phone, personal digital assistant (PDA), or a laptop computer with the capability of creating such an application, and displaying the popular selection of content of the web page on a display device of the mobile computing device. In this example, the display device of the mobile computing device may be smaller display device with respect to, for example, a desktop computer. Thus, having an application that runs on the mobile computing device that displays the popular selection of content of the web page (110) provides for better use of the limited space provided by the display device of the mobile computing device.

The client device may collect and save web page data associated with the selection of portions of web pages, and determine the most user desirable content of the web page (110) based, at least partially, on a popular selection by other users' or a “crowd's” previous selections of text, images, and other content on the web page, web pages that are similar to the web page, or other web pages. In the present example, this is accomplished by the client device (105) requesting the web page (110) from the web page server (115) over the network (120) using the appropriate network protocol (e.g., Internet Protocol (“IP”)), and requesting web page data from a popular selection data storage device (117). Illustrative processes for identifying the most use desirable content of the web page (110) are set forth in more detail below.

To achieve its desired functionality, the client device (105) includes various hardware components. Among these hardware components may be at least one processor (125), at least one data storage device (130), peripheral device adapters (135), and a network adapter (140). These hardware components may be interconnected through the use of one or more busses and/or network connections. In one example, the processor (125), data storage device (130), peripheral device adapters (135), and a network adapter (140) may be communicatively coupled via bus (107).

The processor (125) may include the hardware architecture that retrieves executable code from the data storage device (130) and execute the executable code. The executable code may, when executed by the processor (125), cause the processor (125) to implement at least the functionality of retrieving the web page (110), collect and save web page data associated with the selection of portions of web pages, determine the most user desirable or popular content of the web page (110), and create an application that provides the most user desirable or popular content of the web page (110) upon execution of the application according to the methods of the present specification described below. In the course of executing code, the process (125) may receive input from and provide output to one or more of the remaining hardware units.

The data storage device (130) may store data such as web page data that is processed and produced by the processor (125) or other processing device. As will be discussed, the data storage device (130) may specifically save web page data including, for example, a web page's Uniform Resource Locator (URL), Document Object Model (DOM) tree, popular selections of content in a web page, and sections of content in a web page a user has selected. All of this data may further be stored in the form of a database for easy retrieval when the same or a similar web page is once again accessed by a user.

The data storage device (130) may include various types of memory modules, including volatile and nonvolatile memory. For example, the data storage device (130) of the present example includes Random Access Memory (RAM), Read Only Memory (ROM), and Hard Disk Drive (HDD) memory. Many other types of memory are available in the art, and the present specification contemplates the use of many varying type(s) of memory (130) in the data storage device (130) as may suit a particular application of the principles described herein. In certain examples, different types of memory in the data storage device (130) may be used for different data storage needs, For example, in certain examples the processor (125) may boot from Read Only Memory (ROM), maintain nonvolatile storage in the Hard Disk Drive (HDD) memory, and execute program code stored in Random Access Memory (RAM^{.}

Generally, the data storage device (130) may comprise a computer readable storage medium. For example, the data storage device (130) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The hardware adapters (135, 140) in the client device (105) enable the processor (125) to interface with various other hardware elements, external and internal to the client device (105). For example, peripheral device adapters (135) may provide an interface to input/output devices, such as, for example, output device (150), to create a user interface and/or access external sources of memory storage, such as, for example, popular selection data storage device (117), As will be discussed below, an output device (150) may be provided to allow a user to interact with and adjust the amount and type of content selected within a web page (110).

Peripheral device adapters (135) may also create an interface between the processor (125) and a printer, display device, or other media output device. For example, in an example where the client device (105) is a printer, the printer may create one or more physical copies of the popular selection of web page content. Further, in an example where the client device (105) is a mobile computing device, the mobile computing device may display the popular selection of web page content. Still further, in an example where the client device (105) is a desktop computer, the desktop computer may select user desirable content of the web page (110) and instruct a communicatively coupled printer to create one or more physical espies of the of the popular selection of web page content. A network adapter (140) may additionally provide an interface to the network (120), thereby enabling the transmission of data to and receipt of data from other devices on the network (120), including the web page server (115) and popular selection data storage device (117).

The popular selection data storage device (117) may be any data storage device that stores web page data associated with popular selections of web page content of a number of web pages, Generally, the popular selection data storage device (117) may comprise a computer readable storage medium. For example, the popular selection data storage device (117) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. The popular selection data storage device (117) may, in place of or in conjunction with the client device (105), collect and save web page data associated with the selection of portions of web pages, and determine the most user desirable content of the web page (110) based, at least partially, on a popular selection by other users' or a “crowd's” previous selections of text, images, and other content on the web page, web pages that are similar to the web page, or other web pages.

The network (120) may comprise two or more computing devices communicatively coupled. For example, the network (120) may include a local area network (LAN), a wide area network (WAN), a virtual private network (VPN), and the Internet, among others.

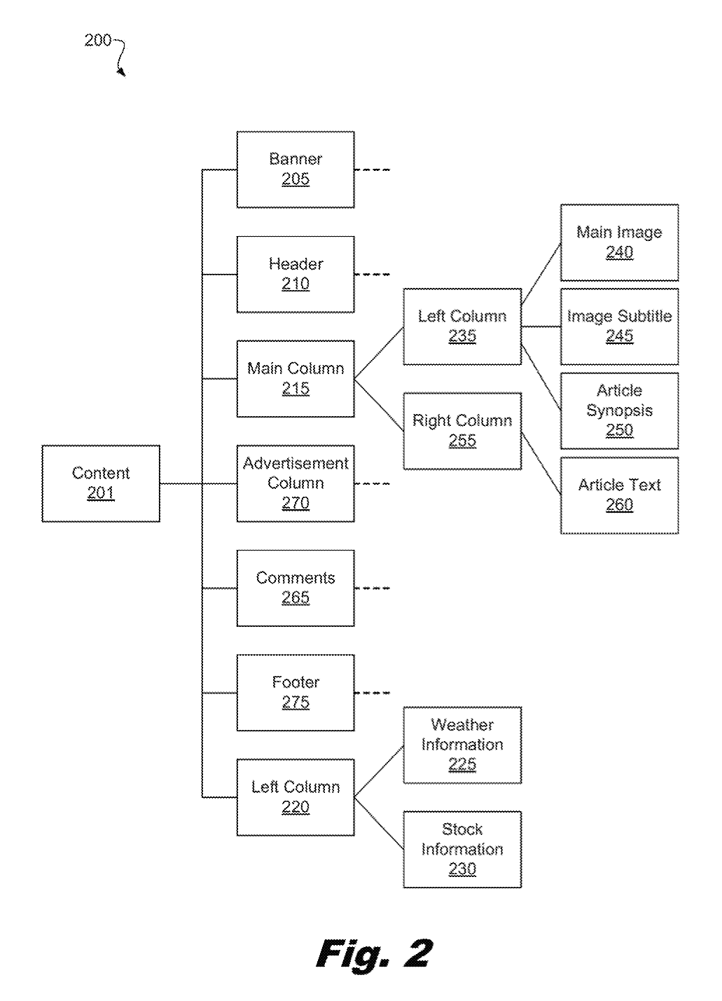

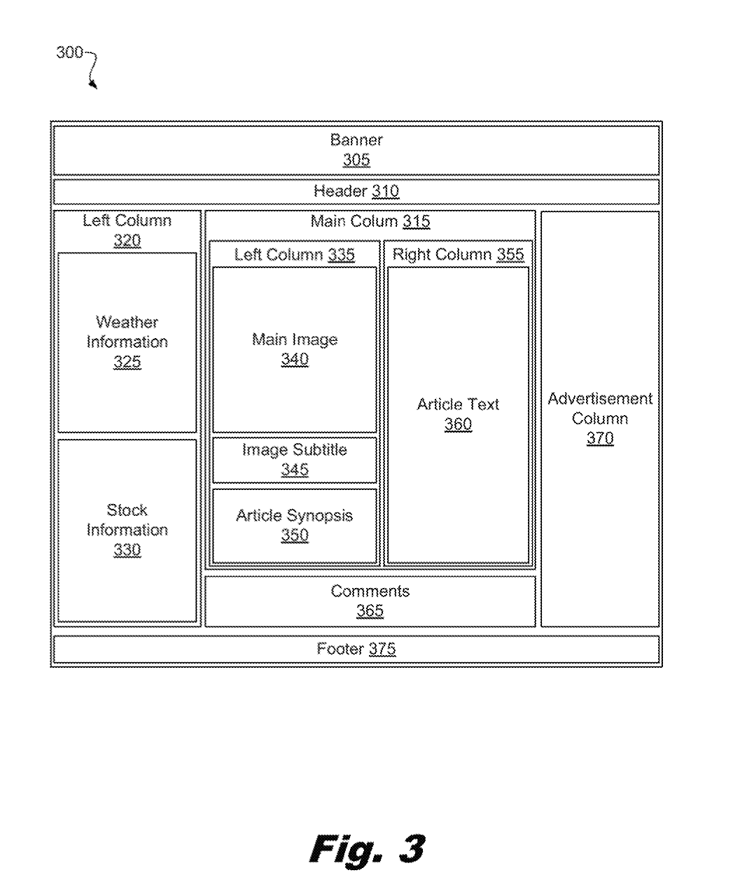

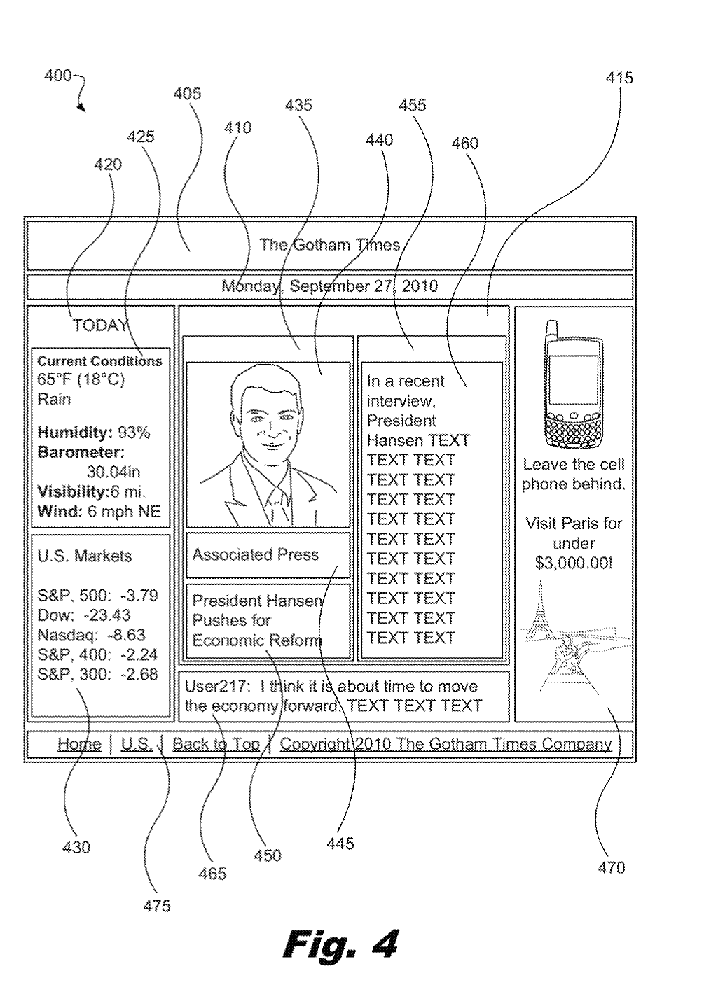

FIG. 2 is a simplified partial representation of a Document Object Model (DOM) tree, FIG. 3 is a layout of an illustrative web page that corresponds to the Document Object Model (DOM) tree of FIG. 2, and FIG. 4 is a diagram of a web page showing the content of the web page corresponding to the Document Object Model (DOM) tree of FIG. 2 and the layout of the web page of FIG. 3. As discussed earlier, various types of data associated with a web page may exist. This data may be saved in order to better select the user desirable content of a web page. However, for purposes of explanation, the present specification uses the illustrative example of saving a Uniform Resource Locator (URL), the web page associated with the Uniform Resource Locator (URL), the web page's Document Object Model (DOM) tree, the particular nodes selected by a user or other users, or combinations thereof. Therefore, although the illustrative example in the present specification and specifically in FIGS. 2-4 may only refer to these types of data being saved in order to better select the appropriate user desirable content from a web page, it can be appreciated that any type of web page data may also be saved so as to achieve similar results. For example, any representation of a web page Document Object Model (DOM) tree, any transformation of a web page Document Object Model (DOM) tree, any hash table created by use of a hash function and meant to represent any selected content of a web page, any modifications of a previous Document Object Model (DOM) tree, or any other type of data representing any content on any web page that has been previously selected by a user may be saved.

In the example shown in FIGS. 4, the web page is from an online news website and includes, for example, an image of a person, an article associated with the person, weather information, stock information, an advertisement, and a comments section, among other elements.

FIG. 2 is an illustrative Document Object Module (DOM) tree (200) showing the hierarchy of Document Object Module (DOM) nodes in the illustrative web page. A Document Object Module (DOM) is a cross-platform and language independent convention for representing and interacting with web page elements in HyperText Markup Language (HTML), eXensible HyperText Markup Language (XHTML) and eXensible Markup Language (XML). The root node in this illustrative web page is the Content (201) node that has seven sub-nodes: the Banner (205) sub-node; Header (210) sub-node, Main Column (215) sub-node; Advertisement Column (270) sub-node; Comments (265) sub-node; Footer (270) sub-node, and the Left Column (220) sub-node. For purposes of illustration, sub-nodes (235-255) are shown only for the Main Column (215) sub-node and the Left Column (220) sub-node. Therefore, it can be appreciated that the Banner (205) sub-node, Header (210) sub-node, Advertisement Column (270) sub-node, Comments (265) sub-node, and Footer (270) sub-node may each include additional sub-nodes of their own. Dashed lines extending to the right of the other sub-nodes, therefore, show the continuation of the sub-nodes with nodes that are not illustrated in FIG. 2.

The Main Column (215) sub-node also includes two sub-nodes Itself, Left Column (235) sub-node and Right Column (255) sub-node, at the next hierarchal level. Left Column (235) sub-node has three sub-nodes at the lowest hierarchal level: Main Image (240) sub-node, Image Subtitle (245) sub-node, and Article Synopsis (250) sub-node. The Right Column (255) sub-node has one sub-node at the lowest hierarchal level: Article Text (260) sub-node,

FIG. 3 depicts the layout (300) of the illustrative web page depicted by the Document Object Module (DOM) tree (FIG. 2, 200) shown in FIG. 2. The Banner (305) holds a location within the layout (300) of a banner or other title. The Advertisement Column (370) holds a location within the layout (300) for advertisements. The Header (310) may contain a number of elements including dates, search fields, and other sub-elements. Similarly, the Footer (375) may contain a number of elements including navigation tabs, links to related sites, terms of use and privacy policies, copyright notices, and other elements. The Comments (265) section may contain ratings and comments from various users of the site who, for example want to leave a comment regarding the article, However, as explained above, for simplicity these elements within the Banner (305), Advertisement Column (370), Header (310), Footer (375), and Comments (265) are not represented on the Document Object Model (DOM) tree of FIG. 2 and therefore also do not appear in the web page layout of FIG. 3.

The Main Column (315) sub-node contains at least some of the user desirable content that a user would want to view, utilize, or adapt The Main Column (315) sub-node contains a Left Column (335) and a Right Column (355). In the Left Column (335), an image is shown in the Main Image (340) section; in this illustrative example the image (FIG. 4, 440) is a person. The Left Column (335) may also include an Image Subtitle (345) and an Article Synopsis (350). The Right Column (355) includes Article Text (360). A Comments (365) section may also be included in the layout (300). The layout (300) may further include a Left Column (320) that may include other user-desirable content such as the Weather Information (325) section and the Stock Information (320) section. Each of these elements (205-275) may have any number of additional sub-elements within the layout (300) of the web page, and may have corresponding nodes within the Document Object Module (DOM) tree (200).

FIG. 4 is diagram of an illustrative web page (400) showing the content of the web page of FIGS. 2 and 3. The content has been simplified for purposes of illustration. There may be a variety of non-visual code and/or elements present in any of the elements (FIG. 3, 305-375). However, according to one aspect of the present systems and methods, this non-visual information is not presented to the user viewing the web page (400) as being part of the user desirable content. Consequently, during the analysis of the web page (400) to determine the user desirable content of the web page (400), non-visual information is not weighted heavily or is not considered at all, As discussed above the user is typically interested in viewing. utilizing, or adapting in some way portions of the web page (400). Advertisements, page navigation, reviews, comments, and links typically contain information that is not directly relevant to the user's interest in the web page (400) and are not directly related to the content the user wishes to view, utilize, or adapt.

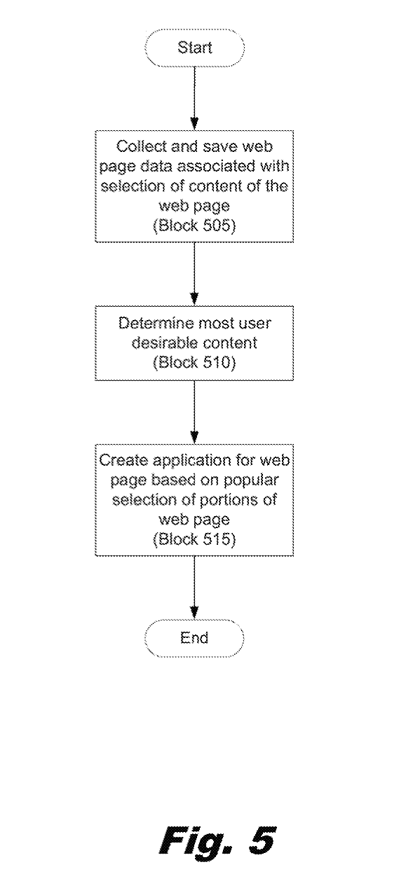

Turning to FIG. 5, a flowchart is depicted showing a method for creating an application for the popular selection of the content on a web page, and present the popular selection of content of the web page to a user for printing, viewing, archiving, or any other useful purpose via the application. in one example, the method may begin by collecting and saving web page data associated with the selection of content of a web page (Block 505). Web page data associated with the selection of content of a web page may be stored, for example, in the popular selection data storage device (117). The web page data stored in the popular selection data storage device (117) may comprise data regarding or associated with selections of content of any number of web pages that the user or other users have made within those web pages.

In one example, throughout the process of collecting web page data associated with the selection of content of a web page (Block 505), the client device (FIG. 1, 105) or other computing device within the system (100) of FIG. 1 may prompt the user or other users to agree to the use of his or her selection of content for one or more web pages (FIG. 4, 400) the user or other users access. For example, the system (FIG. 1, 100) may provide a modal window or other user interface that explains to the users that the users may only utilize the methods and aspects of the present systems and methods if the users also agree to provide or otherwise allow the system (FIG. 1, 100) to use the users' future web page content selections. A license agreement may also be presented to the users, and the users may or may not agree with the license agreement. If the user decides not to agree to the license terms, then the system may not provide the ability to create an application for the popular selection of the content on a web page to the users, and may restrict the users' access to such applications. However, if the user agrees to the license, then the users' future web page content selections may be sent to the popular selection data storage device (FIG. 1, 117) for storage and for use by the user and other users in the future. Further, in one example, the collection of web page data associated with the selection of content of a web page (Block 505) may be performed in accordance with established privacy law and practices of the jurisdiction in which the present methods are being practiced. Still further, the collection of web page data associated with the selection of content of a web page (Block 505) may be performed with an appropriate level of anonymity with respect to the users and with the users' permission.

After data relating to the selected portions of web pages has been saved to the popular selection data storage device (117) (Block 505), the client device (FIG. 1, 105) or other computing device of the system (100) of FIG. 1 may then access the popular selection data storage device (117) and determine the most user desirable content of the web page (Block 510) based, at least partially, on a popular selection of text, images and other content made within the web pages by the user or other users.

In one example, the popular selection data storage device (117) may save a Document Object Model (DOM) representation (FIG. 2, 200) of each web page (FIG. 1, 110; FIG. 4, 400) accessed by the user or other users (Block 505). As described above, the crowd consensus or popular selection may be determined by any method and associated algorithms that aggregate the statistical distribution of what parts of a web page have been selected previously, and determines what portions of the web page are considered to be most popular or are part of a consensus of one or more people. These methods of determining the crowd consensus or popular selection may include, for example, by a frequency count, a voting scheme, a weighted counting scheme, a ranking of a type of selection, or combinations thereof, among others.

In one example, a counter may be added to each DOM element (FIG. 2, 201-275) in each web page, In this example, each time the user or other users select a DOM element (FIG. 2, 201-275), the counter may increment for that DOM element (FIG. 2, 201-275), This may be performed for every DOM element (FIG. 2, 201-275) within the web page (FIG. 1, 110; FIG. 400) as they are selected by the user or other users. Data relating to the number of times a DOM element (FIG. 2, 201-275) has been selected by the user or other users may then be saved (Block 505) along with other data associated with the web pages.

In one example, the client device (FIG. 1, 105) may then determine if enough of the DOM elements (FIG. 2, 201-275) or other portions of each web page were selected by the user or other users within a threshold number of times (Block 510). This threshold may be predetermined by, for example, the client device (FIG. 1, 105), or may be a user-definable threshold. In the above example, if a DOM element (FIG. 2, 201-275) or other portion of the web page (FIG. 4, 400) is selected by the user or other users at least, for example, ten times, then that portion of the web page is determined to be a user desirable or popular selection.

In another example, the selection of the user desirable content of the web page (FIG. 4, 400) may be performed using a fraction of times a particular portion of the web page (FIG. 4, 400) was selected. In this example, if a particular node or other portion of the web page has been selected a number of times more than other portions of the web page above a predetermined fraction, then that portion of the web page is presented to the user as a crowd consensus or popular selection. In one example, the fraction may be higher than about 0.8. In another example, the fraction may be higher than about 0.6.

Further, in yet another example, the selection of the user desirable content of the web page (FIG. 4, 400) may be performed using a variance of a selection of a portion of the web page (FIG. 4, 400). In this example, it is determined how consistently a particular node or portions of he web page (FIG. 4, 400) is selected. In still another example, the selection of the user desirable content of the web page (FIG. 4, 400) may be performed using correlations between how related nodes or portions of the web page (FIG. 4, 400) are selected.

After the most user desirable content of the web page is determined (Block 510), the client device (FIG. 1, 106) or other computing device may create an application for the we page based on the popular selection of portions of the web page (Block 515). The application may be named after, or otherwise associated with the web page from which the application was created. In one example, a title identification algorithm may be run by, for example, the client device (105) regarding the content of the web page, and a title may be assigned to the application based in the identification provided by the client device (105).

After creation of the application (Block 515), the created application may be available to users for use via, for example, a network, or computer program product. In one example, a user may download the application created, In another example, the created application may be available to users as a computer program product, Upon running the application, the application may then provide the user with the most user desirable or popular content for printing, viewing on an output device, archiving, or any other useful purpose. Computer program code for carrying out operations of, for example, the method of FIG. 5, may be written in an object oriented programming language such as Java, Smalltalk, or C++, among others. However, computer program code for carrying out operations of, for example, the method of FIG. 5, may also be written in conventional procedural programming languages, such as the “C” programming language or similar programming languages, The program code may execute entirely on the client device (FIG. 1, 105), partly on the client device (FIG. 1, 105), as a stand-alone package of machine readable instructions (such as software), partly on the client device (FIG. 1, 105) and partly on a remote computer or entirely on the remote computer or server. In the latter scenario, the remote computer may be connected to the client device (FIG. 1, 105) through a local area network (LAN) or a wide area network (WAN), or the connection may be made to an external computer (for example, through the Internet using an Internet Service Provider).

Once a user has obtained and executed the application on the client device (FIG. 1, 105), the application may provide to the user the most desirable content for that web page. For example, if the user has executed the application and accessed, for example, the web page (400) of FIG. 4, the application may then provide the user with just the main column section (FIG. 2, 215; FIG. 3, 315; FIG. 4, 415) of the web page (400) if it is determined that the most user desirable or popular content of that web page was the main column section (FIG. 2, 215; FIG. 3, 315; FIG. 4, 415). However, if the most user desirable or popular content of the web page was the main column section (FIG. 2, 215; FIG. 3, 315; FIG. 4, 415) and the stock information section (FIG. 2, 230; FIG. 3, 330; FIG. 4, 430), then the application may then provide the user with just the main column section (FIG. 2, 215; FIG. 3, 315; FIG. 4, 415) and the stock information section (FIG. 2, 230; FIG. 3.330; FIG. 4, 430) of the web page (400).

The application may provide the most user desirable or popular portions of the web page to the user via an output device (FIG. 1, 150). For example, if the client device is a printer, then the application may be provided on the printer (105). The application may provide the printer (105) with data relating to just the most user desirable or popular portions of the web page, The printer (105) may then print out a hard copy of the user desirable or popular content of the web page (400) using, for example, an inkjet pen (150).

In another example, the client device (105) may be a mobile phone such as a smart phone (105). The application may be downloaded to, or otherwise provided on the mobile phone (105). The application may provide the mobile phone (105) with data relating to just the most user desirable or popular portions of the web page. The mobile phone (105) may then present the most user desirable or popular portions of the web page on a display device (150) of the mobile phone (105).

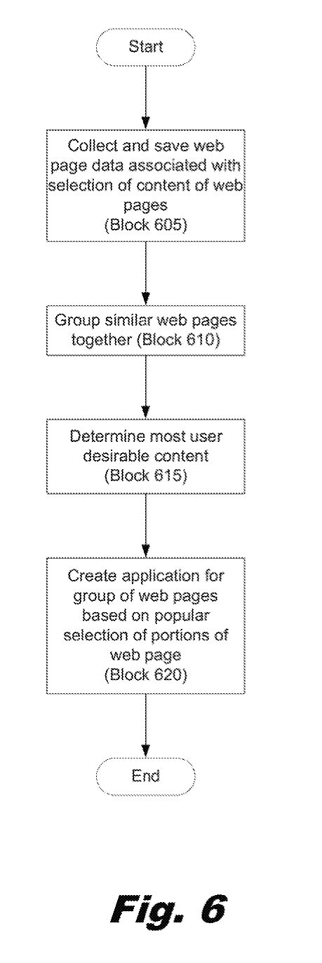

Turning now to FIG. 6, a flowchart depicting an illustrative method for creating an application for the popular selection of the content on web pages, and presenting the popular selection of content of the web pages to a user for printing, viewing, archiving, or any other useful purpose via the application is shown. As similarly discussed above in connection with FIG. 5, in one example, the method may begin by collecting and saving web page data associated with the selection of content of a plurality of web pages (Block 605). Web page data associated with the selection of content of the web pages may be stored, for example, in the popular selection data storage device (117). The web page data stored in the popular selection data storage device (117) may comprise data regarding or associated with selections of content of any number of web pages that the user or other users have made within those web pages.

The popular selection data storage device (117) or other computing device within the system (FIG. 1, 100) may then group similar web pages together (Block 610). Similar web pages may include, for example, any web page having similar characteristics as compared to another web page. For example, a similar web page may be similar in the type of template used to arrange the text, images, or other content displayed on the web page. A similar web page may also be similar because, although the web page address or Uniform Resource Locator (URL) is not entirely identical, the domain name within the Uniform Resource Locator (URL) is the same. Additionally, a similar web page may be similar in the content displayed on the web page.

In one example, to find sets of similar web pages, a template matching algorithm run by, for example, the client device (105), may be used. The template matching algorithm may determine, among web pages for which web page data has been saved, which web pages were generated by or created using the same template. Each web page may be compared with any web page available on the World Wide Web or other documents accessed via the Internet or other network.

In another example, the template matching algorithm run by, for example, the client device (105) may determine, among web pages from the same site, which web pages were generated by or created using the same template. In this example, the template matching algorithm may determine which web pages were generated by or created using the same template among web sites with the same domain name within their respective Uniform Resource Locators (URLs),

After similar web pages have been grouped together (Block 610), the system (FIG. 1, 100) may then determine the most user desirable content within the groups of web pages (Block 615). This may be performed by the client device (FIG. 1, 106) or other computing device of the system (100) of FIG. 1. The client device (FIG. 1, 105) may then access the popular selection data storage device (117) and determine the most user desirable content of the groups of we pages (Block 615) based, at least partially, on a popular selection of text, images, and other content made within the web pages by the user or other users.

In one example, the popular selection data storage device (117) may save a Document Object Model (DOM) representation (FIG. 2, 200) of each group of web pages accessed by the user or other users (Block 605). In one example, a counter may then be added to each similar DOM element (FIG. 2, 201-275) in each web page within the group of web pages. In this example, each time the user or other users select a similar DOM element (FIG. 2, 201-275) in any of the web pages within the group of web pages, the counter may increment for that DOM element (FIG. 2, 201-275). This may be performed for every similar DOM element (FIG. 2, 201-275) within the group of web pages (FIG. 1, 110; FIG. 4, 400) as they are selected by the user or other users. Data relating to the number of times a similar DOM element (FIG. 2, 201-275) within the group of web pages has been selected by the user or other users may then be saved (Block 505) along with other data associated with the group of web Pa

In one example, the client device (FIG. 1, 105) may then determine if enough of the DOM elements (FIG. 2, 201-275) or other portions of each web page within the group of web pages were selected by the user or other users within a threshold number of times (Block 615). This threshold may be predetermined by, for example, the client device (FIG. 1, 105), or may be a user-definable threshold. In the above example, if a DOM element (FIG. 2, 201-275) or other portion of the web pages (FIG. 4, 400) is selected by the user or other users at least, for example, ten times, then that portion of the web page is determined to be a user desirable or popular selection of the group of web pages.

In another example, the selection of the user desirable content of the web page (FIG. 4, 400) may be performed using a fraction of times a particular portion of the web page (FIG. 4, 400) was selected. In this example, if a particular node or other portion of the web page has been selected a number of times more than other portions of the web page above a predetermined fraction, then that portion of the web pale is presented to the user as a crowd consensus or popular selection. In one example, the fraction may be higher than about 0.8. In another example, the fraction may be higher than about 0.6.

Further, in yet another example, the selection of the user desirable content of the web page (FIG. 4, 400) may be performed using a variance of a selection of a portion of the web page (FIG. 4, 400). In this example, it is determined how consistently a particular node or portions of tie web page (FIG. 4, 400) is selected, In still another example, the selection of the user desirable content of the web page (FIG. 4, 400) may be performed using correlations between how related nodes or portions of the web page (FIG. 4, 400) are selected.

After the most user desirable content of the group of web pages is determined (Block 615), the client device (FIG. 1, 105) or other computing device may create an application for the group of web pages based on the popular selection of portions of the web page (Block 620). The application may be named after, or otherwise associated with the group of web pages from which the application was created. In one example, a title identification algorithm may be run by, for example, the client device (105) regarding the content of the group of web pages, and a title may be assigned to the application based in the identification provided by the client device (105).

After creation of the application (Block 620), the created application may be available to users for use via, for example, a network, or computer program product. In one example, a user may download the application created. In another example, the created application may be available to users as a computer program product. Upon running the application, the application may then provide the user with the most user desirable or popular content for printing, viewing on an output device, archiving, or any other useful purpose. Computer program code for carrying out operations of, for example, the method of FIG. 6, may be written in an object oriented programming language such as Java, Smalltalk, or C++, among others. However, computer program code for carrying out operations of, for example, the method of FIG. 6, may also be written in conventional procedural programming languages, such as the “C” programming language or similar programming languages. The program code may execute entirely on the client device (FIG. 1, 105), partly on the client device (FIG. 1, 105), as a stand-alone package of machine readable instructions such as software), partly on the client device (FIG. 1, 105) and partly on a remote computer or entirely on the remote computer or server. In the latter scenario, the remote computer may be connected to the client device (FIG. 1, 105) through a local area network (LAN) or a wide area network (WAN), or the connection may be made to an external computer (for example, through the Internet using an Internet Service Provider).

Once a user has obtained and executed the application on the client device (FIG. 1, 105), the application may provide to the user the most desirable content for that group of web pages. For example, if the user has executed the application and accessed, for example, the web page (400) of FIG. 4, the application may then provide the user with just the main column section (FIG. 2, 215; FIG. 3, 315; FIG. 4, 415) of the web page (400) if it is determined that the most user desirable or popular content of that group of web pages was the main column section (FIG. 2, 215; FIG. 3, 315; FIG. 4, 415). However, if the most user desirable or popular content of the group of web pages was the main column section (FIG. 2, 215; FIG. 3, 315; FIG. 4, 415) and the stock information section (FIG. 2, 230: FIG. 3, 330; FIG. 4, 430), then the application may then provide the user with just the main column section (FIG. 2, 215; FIG. 3, 315; FIG. 4, 415) and the stock information section (FIG. 2, 230; FIG. 3, 330; FIG. 4, 430) of the web page (400).

The example method of FIG. 6 is advantageous for use with a group of web pages that have the same template, but change at periodic intervals. In one example, the group of web pages may be the “front page” to an online news outlet such as the example depicted in FIG. 4, in this example, the web, page may change, for example, daily. However, although the web page may be updated on a daily basis, the general layout of the web page may remain the same. In this example, the most user desirable or popular portions of the group of web pages may then he the main column section (FIG. 2, 215; FIG. 3, 315; FIG. 4, 415) of the web page (400) for that group of web pages since this may be the portion of the group of web pages that is selected the most within each daily front page. Thus, in this example, the application may print out or render on a display device the updated main column section (FIG. 2, 215; FIG. 3, 315; FIG. 4, 415) within the web page (400) for any day the user accesses the web page.

The application may provide the most user desirable or popular portions of the group of web pages to the user via an output device (FIG. 1, 150). For example, if the client device (FIG. 1, 105) is a printer, then the application may be provided on the printer (105). The application may provide the printer (105) with data relating to just the most user desirable or popular portions of the group of web pages. The printer (105) may then print out a hard copy of the user desirable or popular content of the group of web pages using, for example, an inkjet pen (150).

In another example, the client device (105) may be a mobile phone such as a smart phone (105), The application may be downloaded to, or otherwise provided on the mobile phone (105), The application may provide the mobile phone (105) with data relating to just the most user desirable or popular portions of the group of web pages. The mobile phone (105) may then present the most user desirable or popular portions of the web pages on a display device (150) of the mobile phone (105).

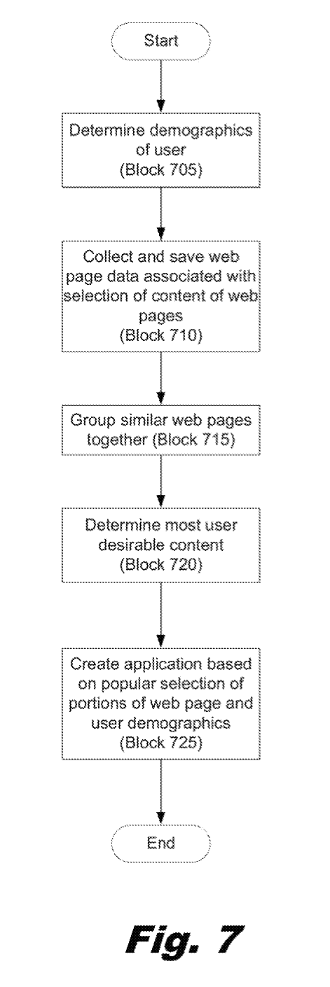

FIG. 7 is a flowchart depicting an illustrative method for creating an application for the popular selection of the content on web pages using a popular selection of users with similar characteristics or demographics. Throughout the present specification and in the appended claims the terms “characteristics” and “demographics” may be used interchangeably to be broadly interpreted as any aspect of the user's and other users' actions, and both physical and mental attributes, qualities, and traits. The method of FIG. 7 may start by determining characteristics or demographics of the user (Block 705). In one example, this may be performed by presenting a modal window to a user, and requesting the user to enter information about him or herself, In another example, the characteristics or demographics may be determined by monitoring the user's activities, and determining the user's characteristics or demographics from those activities. For example, the user may access particular web sites or web pages that may be indicative of the user's occupation. In this example, if the user accesses web sites or web pages containing technical documents, then it may be determined that the user is a scientist or engineer. In another example, the user may select portions of a number of web pages that may be indicative of the user's age. In this example, if the user selects portions of a web page that relate to newer styles of men's clothing, then it may be determined that the user is a male between the ages of 20 and 30.

The characteristics or demographics gleaned from the user may include any information particular to the user including, for example, the user's age, gender, race, nationality, creed, place of residence, place of birth, past domiciles, occupation, interests, associations, accolades, languages spoken, places visited, marital status, family status, sexual orientation, political affiliation, highest education level achieved, and combinations of these, among others, In another example, actions taken by the user in connection with the selection of portions of the web page may also be gleaned from the user. These actions may include, for example, whether the user tends to make relatively smaller selections or relatively larger selections within the web page, or whether the user tends to include images as well as text when selecting portions of a web page.

In one example, the client device (FIG. 1, 105) or other computing device within the system (100) of FIG. 1 may prompt the user or other users to agree to the use of information regarding his or her demographics. For example, the system (FIG. 1, 100) may provide a modal window or other user interface that explains to the users that the users may only utilize the methods and aspects of the present systems and methods if the users also agree to provide or otherwise allow the system (FIG. 1, 100) to use the users' demographic information or glean demographic information from his or her activities on the client device (105) or other computing device of the system (FIG. 1, 100). A license agreement may also be presented to the users, and the users may or may not agree with the license agreement. If the user decides not to agree to the license terms, then the system may not provide the ability to create an application for the popular selection of the content on a web page to the users, and may restrict the users' access to such applications. However, if the user agrees to the license, then the users' demographic information may be sent to the client device (FIG. 1, 105), the popular selection data storage device (FIG. 1, 117), or other computing device of the system FIG. 1, 100) for storage and for creation of applications.

Once this demographic information has been received, the method may continue by collecting and saving web page data associated with the selection of content of a plurality of web pages (Block 710) made by the user and other users. Next, the system (100) may group similar web pages together (FIG. 6, Block 610; FIG. 7, 715) and, or in the alternative, determine the most user desirable content of the web page or group of web pages (FIG. 5, Block 510; FIG. 6, Block 615; FIG. 7, Block 720).

Using the demographics gleaned from the user, the client device (105) or other computing device within the system (100) may then create an application based on the user desirable or popular selections of portions of web pages and the demographics of the user as compared to other users who have made selections of the web pages and those other user's demographics (Block 725), In one example, the demographics of other users may be matched to some degree with the user's demographics. Once a match has been determined, an application may be presented to the user that has been created for other users whose demographics match that of the user, For example, if it has been determined via the gleaned demographics that the user is a female accountant between the ages of 25 and 35, then the system may provide the user with an application that has been created by other users who are also female accountants between the ages of 25 and 35. This example may prevent overloading the user with irrelevant applications and may prevent the need to create an application for each individual user.

In another example, the demographics gleaned from the user may be used by the client device (105) or other computing device within the system (100) to create an application based on the user desirable or popular selections of portions of web pages and the demographics of the user as compared to other users who have made selections of the web pages and those other user's demographics (Block 725), In this example, the user desirable or popular selections of other users with similar demographics as compared to the users demographics may be used to create the application (Block 725). For example, if it has been determined via the gleaned demographics that the user is a female accountant between the ages of 25 and 35, then the system (100) may match the user's demographics with the demographics of other user's. Then the other users' popular selections may be used in creating the application for the user.

In the above examples, the collection of web page data (FIG. 5, 505; FIG. 6, 505; FIG. 7, 710) may be performed on “public” web pages and web sites; for example, web pages and web sites that do not prompt for a login, and appear substantially similar to all visitors to the same URL. This may ensure that the users' selected portions match with respect to each other, and create an application that may provide the user desirable or popular portions of the web page or web pages.

Further, in one example, generated applications may be periodically tested to ensure that the applications still produce valid results. In some instances, originating web pages or groups of web pages may be removed from the World Wide Web or otherwise made not available for access, In other instances, originating web pages or groups of web pages may have been altered as to its layout, structure, or template so as to no longer provide valid results. Therefore, if upon periodic testing of these web pages and groups of web pages, the web pages fail, then the application may be temporarily removed from availability to users. For example, the applications may be removed temporarily if they fail to produce valid results over a period of a week, In one example, if these applications fail over a long enough period, then they may be removed completely. In one example, the period for permanent removal of the application may be, for example, a month.

The specification describes and figures illustrate a method and system of creating an application for the popular selection of content on a web page. The method may comprise collecting web page data associated with a web page, the web page data comprising a selection of content on the web page, determining among the selection of content of the web page, which content is popular, and creating an application based on the popular selection of content of the web page. This creation of applications for popular web page content may have a number of advantages, including ease of presenting selected portions of a web page to a user that reflects what most users want to select while reducing or eliminating the need for manual selection by the user, These advantages would assist a user in printing, or archiving only desired portions of a web page, and viewing these desirable portions on computing devices with smaller screens such as a mobile phone. All of these advantages are possible without extra programming or configuration needed to add new web sites or identify new web sites. Further, no cooperation is needed from the web site publisher, web page server administrator, or other party.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of creating an application for the popular selection of content on a web page (FIG. 4, 400) comprising:
collecting web page data associated with a web page (FIG. 4, 400), the web page data comprising a selection of content on the web page (FIG. 4, 400) (Block 505);
with a processor, determining among the selection of content of the wets page, which content is popular (Block 510); and
creating an application based on the popular selection of content of the web page (Block 515).

2. The method of claim 1, in which determining among the selection of content of the web page, which content is popular (Block 510) comprises:
incrementing a counter each time a document object model element 2, 201-275) is selected;
determining if the document object model element (FIG. 2, 201-275) was selected by other users above a predetermined fraction as compared to other document object model elements; and
assigning the document object model element (FIG. 2, 201-275) as a popular document object model element (FIG. 2, 201-275) if it was selected by other users above the predetermined fraction.

3. The method of claim 1, further comprising:
determining a characteristic of a use (Block, 705);
matching the user's characteristic with other user's with a common characteristic;
creating an application based on popular selection of portions of the web page common between the user and other users (Block 725).

4. The method of claim 1 in which the characteristic comprises an action taken by the user in selecting portions of the web page, in which the action comprises the size of content selected within the web page, the inclusion of text within the selected portions of the web page, the inclusion of images within the selected portions of the web page, or combinations thereof,

5. The method of claim 3, in which the characteristic comprises a gender, race, nationality, creed, place of residence, place of birth, past domiciles, occupation, interests, associations, accolades, languages spoken, places visited, marital status, family status, sexual orientation, political affiliation, highest education level achieved, or combinations thereof.

6. The method of claim 2, in which the predetermined fraction is user definable.

7. The method of claim 1, further comprising receiving a users permission to use the users selections of content in web pages for determining among the selection of content of the web page, which content is popular (Block 510).

8. A method of creating an application for the popular selection of content within a group of web pages (FIG. 4, 400) comprising:
collecting web page data associated with a plurality of web pages (FIG. 4, 400), the web page data comprising a selection of content within the web pages (FIG. 4, 400) (Block 605):
grouping similar web pages (FIG. 4, 400) together within the plurality of web pages (Block 610);
with a processor, determining among the selection of content of a group of web pages, which content is popular (Block 615); and
creating an application based on the popular selection of content of the group of web pages (Block 620).

9. The method of claim 8, in which grouping similar web pages (FIG. 4, 400) together within the plurality of web pages (Block 610) comprises grouping web pages having the same template.

10. The method of claim 8, in which determining among the selection of content of a group of web pages, which content is popular (Block 615) comprises:
incrementing a counter each time a document object model element (FIG. 2, 201-275) of is selected in the group of web pages:
determining if the document object model element (FIG. 2, 201-275) was selected by other users above a predetermined fraction as compared to other document object model elements; and
assigning the document object model element (FIG. 2, 201-275) as a popular document object model element (FIG. 2, 201-275) if it was selected by other users within the fraction among the group of web pages.

11. The m of claim 10, in which the predetermined fraction is user definable.

12. The method of claim 8, further comprising receiving a user's permission to use the user's selections of content in the group of web pages for determining among the selection of content of the group of web pages, which content is popular (Block 510).

13. A system for creating an application for tine popular selection content on a web page (FIG. 4, 400) comprising:
a data storage device (FIG. 1, 117) that stores web page data associated with web pages (FIG. 4, 400), the web page data comprising a selection of content on the web page (FIG. 4, 400); and
a processor (FIG. 1, 125), communicative coupled to the data storage device (FIG. 1, 117), that determines among the selection of content of the web pages, which content is popular, and creates, an application based on the popular selection of content of the web pages (FIG. 4, 400).

14. The system of claim 13, further comprising an output device (FIG. 1, 150) that provides the popular selection of content of the we pages (FIG. 4, 400) via the application to a user.

15. The system of claim 13, in which the client device (FIG. 1, 105) is a printer or a mobile phone.
